(19) United States
(12) Patent Application Publication
(10) Pub. No.: US 2003/0202017 A1
(43) Pub. Date: Oct. 30, 2003

(54) Dialog control system

(75) Inventors: Toshiyuki Fukuoka, Kawasaki (JP); Hitoshi Okumura, Kawasaki (JP); Ryosuke Miyata, Kawasaki (JP); Yuichi Uwabu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/270,102

(22) Filed: Oct. 15, 2002

Related U.S. Application Data
(63) Continuation of application No. PCT/JP00/02869, filed on Apr. 28, 2002.

(51) Int. Cl. G09G 5/00

(52) U.S. Cl. 345/809; 345/811

(57) ABSTRACT

There is provided a system for controlling a dialog flow so that a user can purchase goods with the feeling closer to face-to-face sales in the sales of goods using the Internet.

A dialog with a user is input/output via a dialog interface 10. A dialog contents analyzing part 20 analyzes the contents of a dialog input by the user. A feature value control part 40 extracts/manages a feature value to be a parameter for evaluating the state of the user from the analysis results. A dialog flow control part 70 controls a dialog flow by dynamically inferring the contents of a dialog to be output to the user, based on the feature value of a feature value control part 40, a dialog history of a dialog contents history holding part 30, goods knowledge of a goods knowledge part 50, a goods sales strategy of a goods sales strategy knowledge part 60, and held dialog knowledge 71. A dialog expression expressing part 80 generates/outputs the expression of a dialog representing the contents of the dialog inferred by the dialog flow control part 70, based on dialog expression knowledge 81.

### TECHNICAL FIELD

The present invention relates to a system that controls a dialog with a user, for effectively conducting sales processing called EC (electronic commerce) in which goods are sold/purchased via the Internet, a network system, a communication system such as a telephone and a wireless system, or the like. In particular, the present invention relates to a system for controlling a dialog with a user so as to provide an environment in which a user can purchase goods naturally without any uncomfortable feeling when purchasing them via the Internet, using a computer, unlike conventional face-to-face sales at a store.

### BACKGROUND ART

The Internet is spreading. The Internet enables information to be exchanged by using various services. In particular, numbers of EC systems via the Internet using a World-Wide Web or the like are being developed. A user considering the purchase of goods displays a web page on a client machine, and checks the advertisement of the goods by a vendor that provides the web page. Then, the user exchanges information with a web server to collect information on the goods that the user desires to purchase, and conducts a purchase procedure on-line. In most cases, an electronic catalog is provided so as to help the user to purchase the goods, and the user browses through the electronic catalog to select the goods that the user desires to purchase. Furthermore, information on goods and comments from a store are listed on a homepage of the Internet, and an application for the user to purchase goods is provided as an electronic form. When the user decides to purchase goods, the user fills the form with required information, and signs up for the purchase by using a button or the like. Furthermore, in some cases, the user may input credit information such as a credit No. required for payment.

In the above-mentioned prior art, when the user purchases goods on the Internet, basically, the user operates the EC to find interesting goods, and signs up for the purchase of the goods on-line, thereby conducting a purchase procedure. The conventional EC using the Internet has the following problems.

A first problem of the conventional EC using the Internet is that perception of user's needs in selection of purchases and a suggestion about purchases in accordance with the user's needs are insufficient. In the conventional EC using the Internet, the user operates the EC, so that a suggestion about purchases in accordance with the user's needs cannot be made. As so-called push-type information service, there are banner advertisement and goods appeal regarding goods recommended by a system. This is a one-sided suggestion, which cannot make a suggestion about purchases in accordance with the user's needs.

In the case of the conventional face-to-face sales at a store, a salesclerk finds out user's demand during conversation with the user, and can dynamically suggest goods suitable for the user's demand.

A second problem of the conventional EC using the Internet is that when the user has a question about the function and quality of goods, the user cannot easily obtain information on them. In the conventional EC using the Internet, the user is required to operate the EC, so that the user should search for a homepage or the like in which the goods are made public to find out the corresponding explanation and specification for understanding. When the user cannot understand the terms and meanings of the explanation and specification, the user is further required to find out information describing the terms and meanings. In the conventional EC system, it is apparently considered that the information on goods is sufficiently made public, and the convenience to the user is high. However, irrespective of a large amount of provided explanation and specification, it is rather difficult for the user to find out necessary and sufficient information that answers the user's question. Furthermore, information service is static and one-sided. Therefore, the answer cannot be provided in accordance with the knowledge about goods and the contents of the question of the system user.

In the case of the conventional face-to-face sales at a store, even if the user has poor knowledge about goods or about the terms and units used in the specification, or the contents of the user's question are unclear, a salesclerk can perceive the answer to the question, which the salesclerk seeks for, during conversation with the user, and grab the core of the unclear question of the user to answer it.

A third problem of the conventional EC using the Internet is that the information provided by a system is static, and the contents of the provided information cannot be changed dynamically in accordance with the impression, reaction, personality, and state of the user using the system. The user reacts variously and has an opinion/impression while exchanging information with the system. Furthermore, even if the reliability of the provided information, the satisfaction in the goods, and the like are varied, the contents of the provided information cannot be changed timely and dynamically in the conventional EC system. Furthermore, the support cannot be changed in accordance with user's personality. For example, the explanation that is speedy and reaches the core is preferable for those who are active and decide a matter quickly. In contract, careful explanation, i.e., various explanations of the function and comparison of goods are preferably conducted for those who consider a matter and decide carefully before they decide. The conventional EC system cannot perceive user's reaction to dynamically respond to it or cannot infer user's personality to respond to it dynamically.

In the conventional face-to-face sales at a store, a salesclerk can perceive user's reaction and personality during conversation with the user, and flexibly change the contents of explanation and sales talk.

A fourth problem of the conventional EC using the Internet is that an effective sales strategy and sales know-how that have been developed in face-to-face sales at a store cannot be adopted flexibly. The sales strategy and know-how are very important for the sales of goods, and the fact that the level of the sales strategy and know-how influences the sales of goods cannot be ignored. The sales strategy and know-how are, for example, as follows: in the conventional face-to-face sales at a store, a salesclerk understands the problem and demand of a customer during conversation with the customer, obtains customer's personality and various pieces of information on the customer to change explanation and sales talk dynamically, thereby recommending goods timely. In the conventional EC using the Internet, it was difficult to adopt such strategy and know-how.

On the other hand, in face-to-face sales at a store, a salesclerk not only provides information on goods but also understands the problem and demand of the customer during conversation with the customer, gives explanation easy to understand, and confirms the understanding of the customer. Thus, the customer can purchase goods with enhanced satisfaction by effective sales talk that is performed.

### DISCLOSURE OF INVENTION

In view of the above-mentioned problems, the object of the present invention is to provide a system for controlling the flow of a dialog so that a user can purchase goods with the feeling closer to face-to-face sales in the sales of goods by the EC using the Internet.

In order to solve the above-mentioned problem, the dialog control system of the present invention includes: a dialog interface for inputting/outputting a dialog with a user; a dialog contents analyzing part for analyzing contents of the dialog input by the user; a feature value control part for extracting/managing one or a plurality of feature values to be parameters for evaluating a state of the user based on analysis results of the contents of the dialog by the dialog contents analyzing part; a goods knowledge part for holding goods knowledge; a goods sales strategy knowledge part concerning a goods sales strategy; and a dialog flow control part including dialog knowledge, for controlling a dialog flow by inferring contents of a dialog to be output, based on the feature values from the feature value control part, the goods knowledge of the goods knowledge part, the goods sales strategy of the goods sales strategy knowledge part, and the dialog knowledge, wherein the dialog flow is controlled in accordance with the state of the user.

Because of the above configuration, the state of the user can be evaluated based on the extracted feature values, and the dialog flow control part can dynamically control a dialog flow by inferring the contents of the dialog to be output. Since the goods sales strategy stored in the goods sales strategy knowledge part can be used, the contents of a dialog adopting the sales strategy that have been developed for a long time in conventional face-to-face sales can be provided in accordance with the state of the user.

Furthermore, it is preferable that the dialog flow control system of the present invention includes a dialog contents history holding part for holding a history of the contents of the dialog, wherein the dialog flow control part controls the dialog flow by inferring the contents of the dialog to be output, also based on a dialog history from the dialog contents history holding part.

Because of the above configuration, a dialog flow control considering a dialog flow with the user is made possible.

Furthermore, it is preferable that the dialog flow control system of the present invention includes a dialog expression generating part having dialog expression knowledge holding knowledge regarding a dialog expression, for generating/outputting the contents of the dialog inferred by the dialog flow control part as a dialog expression in accordance with attributes of the user.

Because of the above configuration, the expression of a dialog provided to the user can be changed to an expression in accordance with the attributes of the user (e.g., dialects, male expressions, female expressions, expressions of young people, etc.). Thus, a friendly dialog output is made possible.

Furthermore, if one of the feature values represents reliability of a sales entity of the user, a dialog flow can be controlled in accordance with the reliability of the sales entity of the user.

Furthermore, in the dialog control system of the present invention, it is preferable that the sales entity includes a recommended goods specifying part for specifying goods of which sales is recommended, the goods knowledge part contains information on the recommended goods, information on comparison goods to be a comparison object belonging to a goods category to which the recommended goods belong, and information on an advantage of the recommended goods with respect to the comparison goods, and the dialog flow control part controls a flow of contents of a dialog by inferring the contents of the dialog to be output so as to obtain contents presenting the information on the advantage of the recommended goods to the user based on specification of the recommended goods input from the recommended goods specifying part.

Because of the above configuration, the set recommended goods are allowed to appeal to the user effectively, which contributes to the sales promotion of the recommended goods of the sales entity.

Furthermore, if one of the feature values is set to be a feature value representing a demand of the user for goods regarding a function and quality, and the dialog flow control part controls a flow of contents of a dialog by inferring the contents of the dialog to be output so as to obtain contents of a dialog for obtaining the demand of the user for the goods as a demand investigation mode before obtaining contents presenting the information on the advantage of the recommended goods to the user, the user's demand can be obtained effectively, and goods suitable for the demand of the user can be inferred. Furthermore, the goods suitable for the demand of the user is used as comparison goods and compared with the recommended goods on the sales entity side, whereby the advantage of the recommended goods on the sales entity side is allowed to appeal.

If a flow of contents of a dialog is controlled by inferring the contents of the dialog to be output so as to obtain contents for getting satisfaction points and dissatisfaction points regarding the goods purchased by the user.

Furthermore, it is preferable that the dialog flow control part controls a flow of contents of a dialog by inferring the contents of the dialog to be output so as to obtain contents for asking the user whether or not the user recommends the same goods to an acquaintance, and in a case of obtaining contents of a dialog of an answer that the user recommends the same goods, controls a flow of contents of a dialog by inferring the contents of the dialog to be output so as to obtain contents for seeking for information on the acquaintance, thereby obtaining the information on the acquaintance.

Because of the above configuration, it becomes possible to obtain important information on whether or not further sales promotion of goods by so-called word of mouth is made possible. Furthermore, the standard for varying the reliability feature value with respect to the sales entity can be obtained, and the reliability feature value can be enhanced when recommendation is made.

Furthermore, in the dialog control system of the present invention, it is preferable that goods knowledge part holding the goods knowledge includes knowledge expressed in multi-media, such as an image, a photograph, an animation, and a voice, and can present multi-media information on goods to the user via the dialog interface

Furthermore, if the dialog control system of the present invention has a configuration in which, in a client server system using the Internet, the dialog contents analyzing part, the dialog contents history holding part, the feature value control part, the goods knowledge part, the goods sales strategy knowledge part, the dialog flow control part, and the dialog expression generating part are provided on a server side, and a dialog interface is provided on a client side, a dialog of sales with the user can be realized on the Internet.

The dialog control system of the present invention can be configured using a computer by reading a processing program from a computer-readable recording medium storing processing operations for realizing the above-mentioned dialog control system.

### BRIEF DESCRIPTION OF DRAWINGS

FIG. 1 is a block diagram showing a configuration example of a dialog control system of the present invention.

FIG. 2 is a view showing a simple example of user's knowledge.

FIG. 3 is a view showing a very simple data example of knowledge about goods.

FIG. 4 is a flow chart showing a simple example of a dialog flow in the dialog control system.

FIG. 5 is a flow chart showing an example of flow control of dialog control processing using sales amount information on goods.

FIG. 6 is a flow chart showing a dialog flow for introducing goods recommended by a store.

FIG. 7 is a flow chart showing an example in which a dialog flow is varied depending upon the price range of a goods category and the price of recommended goods.

FIG. 8 is a flow chart showing a dialog flow for confirming the intention of purchasing goods.

FIG. 9 is a flow chart showing a dialog flow in the case where a user who has purchased goods in the past visits a store again.

FIG. 10 is a flow chart showing a dialog flow depending upon the ratio of number of times between the question and the explanation.

FIG. 11 is a flow chart showing a dialog flow depending upon a user input ratio.

FIG. 12 is a view showing a data configuration example of a part of dialog knowledge.

FIG. 13 is a block diagram showing a configuration example of a dialog control system via the Internet of Embodiment 2 according to the present invention.

FIG. 14 is a view showing examples of recording media storing a processing program for realizing a dialog control system of Embodiment 3 according to the present invention.

### BEST MODE FOR CARRYING OUT THE INVENTION

Hereinafter, the dialog control apparatus of the present invention will be described by way of an embodiment with reference to the drawings.

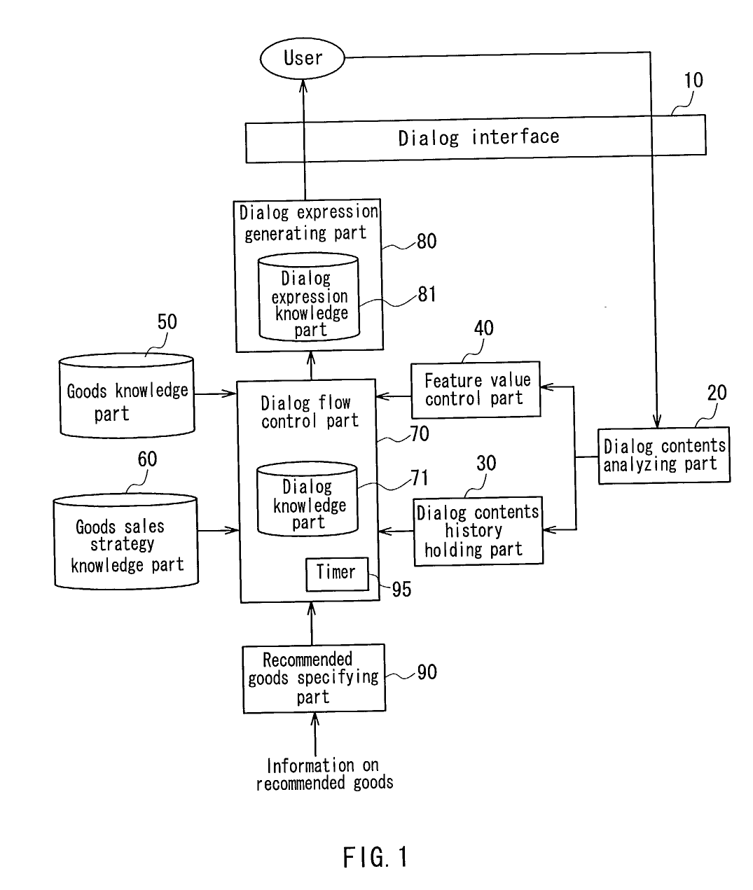

FIG. 1 is a block diagram showing a configuration example of the dialog control system of the present invention. Reference numeral 10 denotes a dialog interface, 20 denotes a dialog contents analyzing part, 40 denotes a feature value control part, 50 denotes a goods knowledge part, 60 denotes a goods sales strategy knowledge part, and 70 denotes a dialog flow control part. The dialog control system further includes a dialog contents history holding part 30 for referring to a dialog history, a dialog expression generating part 80 for obtaining a dialog expression in accordance with user's attributes, and a recommended goods specifying part 90 for inputting goods recommended by a store that is to be a sales entity. The dialog control system further includes a timer 95 for measuring an elapsed time.

The dialog interface 10 is an input/output interface for receiving an input from a user and presenting an output from the system to the user. Examples of the dialog interface 10 include a keyboard that receives a user's input, a pointing device such as a mouse, and a microphone for inputting a voice. Furthermore, as a part for presenting an output from the system to the user, there are a display apparatus including a CRT and a liquid crystal display, a loudspeaker for outputting a voice, a sound source part, and the like. An output of a dialog expression generated by the dialog expression generating part 80 (described later) is presented to the user.

The dialog contents analyzing part 20 analyzes dialog contents from the user input through the dialog interface 10. In the case where input data is a voice, a voice recognition processing part conducts morphemic recognition, syntactic recognition, and semantic recognition. In the case where the input data is text data, syntactic recognition and semantic recognition are conducted. If the input data is input by a pointing device, the dialog contents analyzing part 20 receives the contents instructed by the pointing device. The dialog contents analyzing part 20 converts dialog contents obtained by extracting/analyzing various kinds of information contained in the dialog contents input by the user into a data format that can be understood by the system.

The dialog contents history holding part 30 records and holds a dialog input from the user via the dialog interface 10 and a dialog history presented from the system to the user via the dialog interface 10 as described later. The recorded and held dialog and dialog history are utilized in the case where the past details are referred to when the dialog flow control part 70 controls a dialog flow as described later.

The feature value control part 40 extracts/manages a feature value to be a parameter for evaluating the state of the user based on the analysis results of dialog contents by the dialog contents analyzing part 20. The feature value is dynamically calculated and changed based on the dialog contents input by the user. The dialog flow control part 70 controls a dialog flow in accordance with each feature value as described later. The feature value control part 40 can set a feature value to be a parameter for evaluating the state of the user in accordance with the purpose of using the system. The parameter for evaluating the state of the user can be defined as what represents a feature value regarding the purchase intention of the user in the case where the dialog control system of the present invention is applied to the goods sales support system at a store. The system manager can freely define a feature value regarding the purchase intention of the user. For example, the following feature values are assumed: “reliability feature value” that is a feature value of reliability to be a parameter representing whether or not the user trusts a sales entity; “satisfaction feature value” that represents user's satisfaction in a dialog flow of the system and user's satisfaction in goods recommended and presented by the system; “budget feature value” that represents user's budget state; “demand feature value” that represents user's demand for the function and quality of the goods; “knowledge level feature value” that represents user's knowledge level of the field of goods and user's knowledge level regarding the specification of the goods; “user's inclination feature value” that represents user's positiveness and interest; and the like. It should be understood that these are shown merely for illustrative purposes, and other feature values can also be defined.

As described above, the feature value control part 40 extracts data regarding the feature value set based on the analysis results of the dialog contents by the dialog contents analyzing part 20. Examples thereof will be described below. In the case of the “reliability feature value”, information representing user's purchase history, information representing user's purchase history of goods recommended by the system, information representing user's satisfaction in goods recommended by the system, information representing use frequency of the system, and the like are extracted, and the extracted information is converted to a parameter value of the “reliability feature value”, whereby the “reliability feature value” is calculated. Furthermore, in the case of the “satisfaction feature value”, information representing user's satisfaction in recommendation of goods by the system, information representing user's satisfaction in a dialog flow presented by the system, and the like are extracted, and the extracted information is converted to a parameter value of the “satisfaction feature value”, whereby the “satisfaction feature value” is calculated. In the case of the “budge feature value”, information representing user's budget is extracted from a dialog to obtain the “budge feature value”. In the case of the “demand feature value”, information representing user demand for the function and quality of goods is extracted from a dialog to obtain the “demand feature value”. In the case of the “knowledge level feature value”, for example, information representing user's knowledge level such as the contents and kind of jargon used by the user and the contents of the function which the user seeks for in the goods is extracted from a dialog, and the extracted information is converted to a parameter value of the “knowledge level feature value”, whereby the “knowledge level feature value” is calculated. In the case of the “user inclination feature value”, for example, information representing the positiveness and interest such as whether or not the user tends to conduct price bargaining, the length of a response time, and the presence/absence of a clear demand for the function of goods is extracted from a dialog to obtain the “user inclination feature value”.

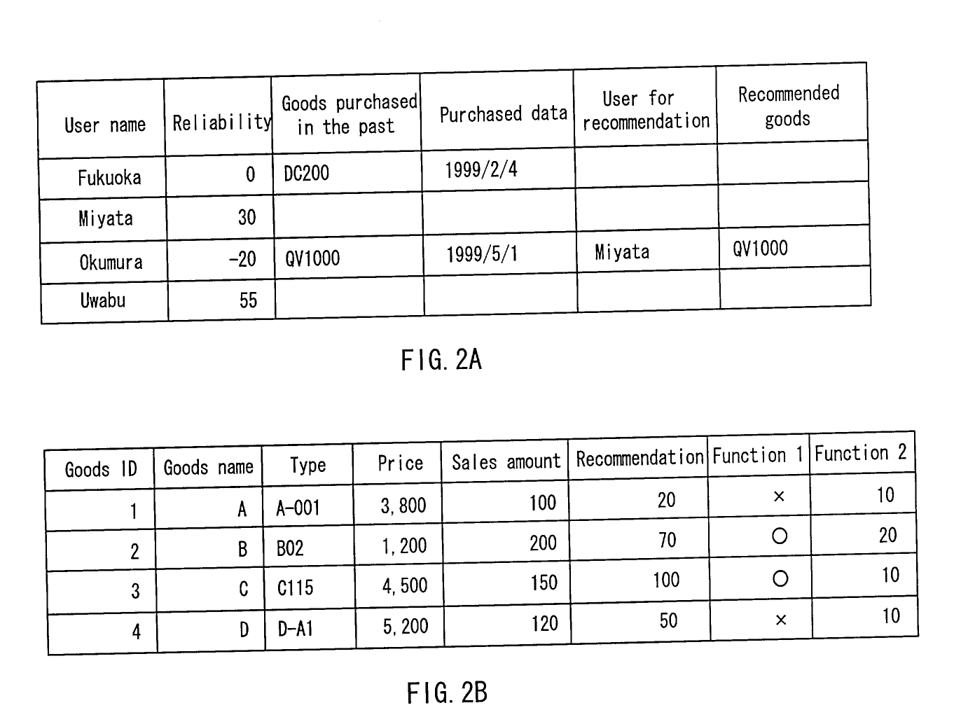

Furthermore, it is preferable that the feature value control part 40 also includes a user knowledge part 41. FIG. 2A shows a simple example of user knowledge. It should be appreciated that the user knowledge shown in FIG. 2A is merely an example, and the present invention is not limited thereto. In the case where information identifying a user is extracted from a dialog with the user, the feature value control part 40 can obtain various kinds of data regarding the user held in the user knowledge part 41, e.g., a purchase history of goods, a purchase time, reliability of a sales entity, and the like, and can use the parameter value thereof as a part of the feature value.

The goods knowledge part 50 is a goods knowledge base, in which various information on goods, e.g., goods ID for identifying goods, goods name, model No. specification, price, sales information on goods, recommendation degree that is a degree to which a sales entity recommends goods, advantage/disadvantage of goods, superior points/inferior points compared with other goods is held. FIG. 2B is a view showing a very simple example of goods knowledge. Needless to say, this is an example, and various goods knowledge is not limited to the example of FIG. 2B.

The above-mentioned information can further contain knowledge expressed in multi-media such as an image, a photograph, an animation, and a voice as goods knowledge. For example, the information contains various kinds information such as the outer appearance of goods, the function of goods, the variation in goods color, the state in which goods are operated, the presentation of exemplary example modified from the goods, the voice uttered by the goods, and the like. For example, assuming a digital camera as goods, the image of the outer appearance of the goods is shown, and if required, examples of photographs taken by the digital camera are presented on the resolution basis. Thus, the goods knowledge can be used for answering the question from the user.

The goods sales strategy knowledge part 60 is a knowledge base holding various knowledge in the sales of goods. An effective sales strategy, sales know-how, and the like that have been developed in face-to-face sales at a store are used as the knowledge base. Needless to say, the goods sales strategy knowledge held in the goods sales strategy knowledge part 60 can be newly added or updated. Thus, by setting dialog contents and a dialog flow using the sales strategy and sales know-how, effective sales can be conducted.

The dialog flow control part 70 controls a dialog flow by inferring the contents of a dialog with the user. The dialog flow control part 70 holds a dialog knowledge part 71. The dialog flow control part 70 controls a dialog flow by inferring the contents of a dialog output based on the feature value from the feature value control part 40, the dialog history from the dialog contents history holding part 30, the goods knowledge from the goods knowledge part 50, the goods sales strategy from the goods sales strategy knowledge part 60, and the dialog contents held in the dialog knowledge part 71. The dialog flow control part 70 can control the dialog flow so that various dialog phases flow naturally in the flow of a dialog with the user. Various dialog phases, for example, the following phases are assumed: greeting, collection of information on the user, collection of information on purchase goods category of the user, collection of information on user's demand, recommendation/suggestion of goods to the user, receiving of a question from the user and answer, presence/absence of satisfaction/purchase intention of the user with respect to the suggested goods, information on acquaintances of the user, processing of goods purchase procedure, and the like. In each dialog phase, various dialog contents are provided, and the dialog contents are held in the dialog knowledge part 71.

In inferring which dialog contents should be used, even in the case where the order of dialog phases is determined as a dialog default, the dialog flow control part 70 can dynamically change a dialog phase flexibly in accordance with the dialog flow with the user, and infer most required and effective dialog contents among the dialog phases.

The dialog flow control part 70 also inserts a dialog for obtaining information that is desired to be collected in the dialog flow. For example, “dialog contents of asking the user about a history of visiting a store” is inferred as the dialog contents to be output. Regarding the dialog contents, the dialog expression generating part 80 (described later) asks the user a question “Have you ever purchased goods at our store?”. If the user answers yes , “dialog contents of asking the user about the satisfaction in goods purchased in the past” is inferred as the dialog contents to be output next. Then, the dialog flow control part 70 controls a dialog flow as follows: “Thank you very much. Are you satisfied with the goods purchased at our store?”. Thus, the dialog flow control part 70 controls a dialog flow so as to obtain information representing user's purchase history and information representing user's satisfaction in the goods recommended by the system.

The dialog expression generating part 80 generates/outputs a dialog expression representing dialog contents inferred by the dialog flow control part 70, and includes a dialog expression knowledge part 81 for holding knowledge about dialog expressions. The dialog expression knowledge part 81 holds dialog expressions corresponding to the dialog contents inferred by the dialog flow control part 70, i.e., dialog expressions suitable as those which are output to the user. It is preferable that the dialog expression knowledge part 81 holds various kinds of languages and dialog expression knowledge on the basis of each dialect. When the dialog flow control part 70 obtains, as a feature value, information that a user is a foreigner whose native language is English”, the dialog flow control part 70 gives the dialog contents together with the information that the language should be English to the dialog expression generating part 80. The dialog expression generating part 80 obtains English expressions of the dialog contents held in the dialog expression knowledge part 81, and outputs them from the dialog interface part 10.

The recommendation goods specifying part 90 specifies goods of which sales is recommended by a sales entity.

Next, the dialog control by the dialog control system will be described by way of an example mainly based on the control of a dialog flow by the dialog flow control part 70.

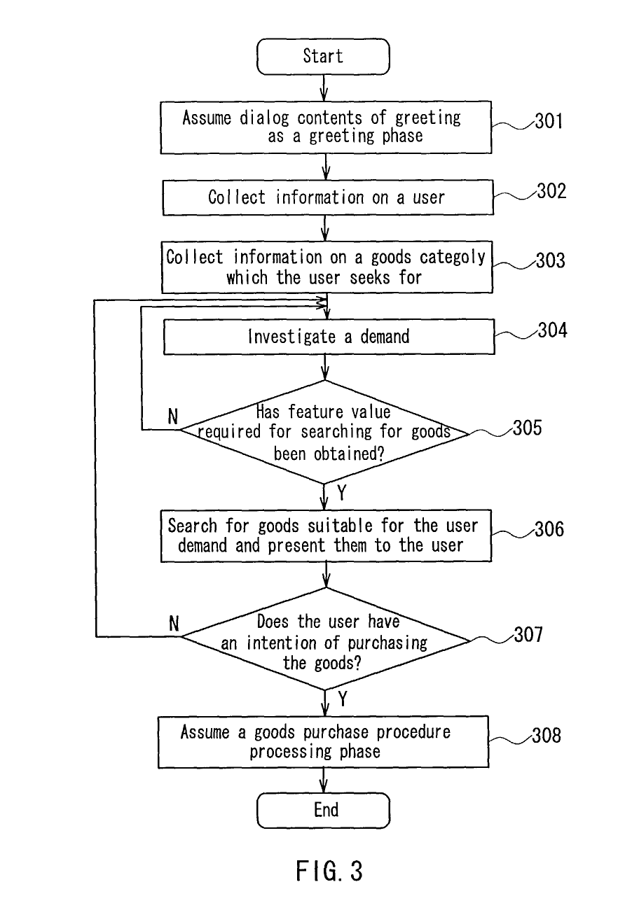

FIG. 3 is a very simple example of a dialog flow by the dialog control system.

First, dialog contents of greeting are assumed as a greeting phase (Operation 301). For example, a letter display or a voice output such as “May I help you?” is assumed. This may be expressed in English and accompanied by Japanese by default setting.

Then, an information collection phase regarding a user is assumed (Operation 302). For example, it may be possible to ask the question “Do you have a membership card of our store?” so as to obtain a user ID. It should be understood that this operation may be omitted. Herein, Operation 302 is provided, and it is assumed that a user ID can be obtained from the user. A feature value is to be obtained based on the information on the user thus obtained.

Next, information on a category of goods which the user seeks for is collected (Operation 303). For example, the question “What kind of goods are you looking for today?” is asked. Herein, it is assumed that the answer “I would like to buy a digital camera” is obtained from the user.

Then, a demand investigation phase is assumed (Operation 304). A dialog flow is controlled so as to obtain a dialog proceeding in which the question for obtaining user's demand for the function and quality of goods is included, whereby user's demand is investigated. For example, in the case where user's “knowledge level feature value” is higher than a predetermined value, the question “How many pixels of a digital camera are required?” regarding the specification is asked. In the case where user's “knowledge level feature value” is not higher than a predetermined value, the question “Which sharpness of an image taken by a digital camera is required among the following examples” is asked, and images on the basis of typical pixel number are presented for selection, whereby user's demand is investigated. A feature value is to be further obtained based on the information obtained regarding the demand.

Next, the information on the demand obtained in Operation 304 is reflected onto the feature value, and it is determined whether or not the feature value required for searching for goods has been obtained (Operation 305). In the case where it is determined the required feature value has been obtained (Operation 305: Y), goods suitable for user's demand (i.e., goods matching or satisfying the feature value that represents user's demand) are searched for and presented to the user (Operation 306). For example, various kinds of information on goods such as goods name, manufacturer, price, and the like is presented. If required, the advantage of the goods, and the advantage of the goods compared with other goods can be output. Herein, it is assumed that a digital camera produced by “A Corporation” is presented as goods suitable for user's demand.

Next, a phase of confirming user's intention of purchasing the goods is assumed (Operation 307). For example, a dialog for confirming the purchase “Digital Camera XXX of Fujitsu Ltd. is most suitable for your demand. Would you like to buy it?” is performed.

If the answer of no intention of purchase is input (Operation 307: N), the process returns to Operation 304 of the demand investigation phase to continue to investigate the demand.

If the user intends to purchase the goods (Operation 307: Y), a goods purchase procedure processing phase is assumed (Operation 308).

Next, an exemplary dialog flow with an application pattern based on the above-mentioned basic pattern by the dialog control system will be described.

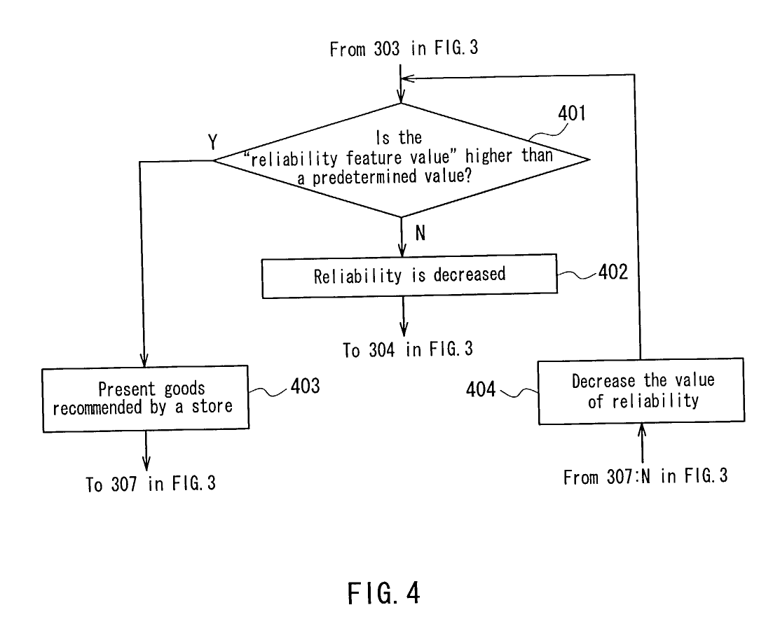

FIG. 4 is a flow chart in which the goods recommended by a store are first presented to a user whose reliability feature value is high, assuming that the use trusts the store, before asking the user for a detailed demand for goods. In the flow chart in FIG. 4, the same processing parts as those in FIG. 3 are not shown.

After information on a category of goods which the user seeks for is collected (Operation 303), it is checked whether or not the “reliability feature value” from the user information obtained in Operation 302 in FIG. 3 is higher than a predetermined value (Operation 401). For the user whose reliability is not higher than a predetermined value (Operation 401: N), a demand investigation phase (Operation 304) is assumed. In this case, the reliability of the store is lower than a predetermined value, for example, the user is not satisfied with the goods recommended previously; therefore, processing of decreasing the reliability is also conducted (Operation 402). For the user whose reliability of the store is high in Operation 401 (Operation 401: Y), the goods recommended by the store (i.e., goods with a high recommendation degree in FIG. 2B) are first presented (Operation 403) before the demand investigation phase. In the case where the user does not decide to purchase the goods (Operation 307: N), the reliability value is lowered (Operation 404). Because of this, regarding regular users who can be considered to have a high reliability with respect to the store, confirmation is conducted without a complicated operation such as demand investigation.

Next, an exemplary dialog flow with another application pattern by the dialog control system will be described.

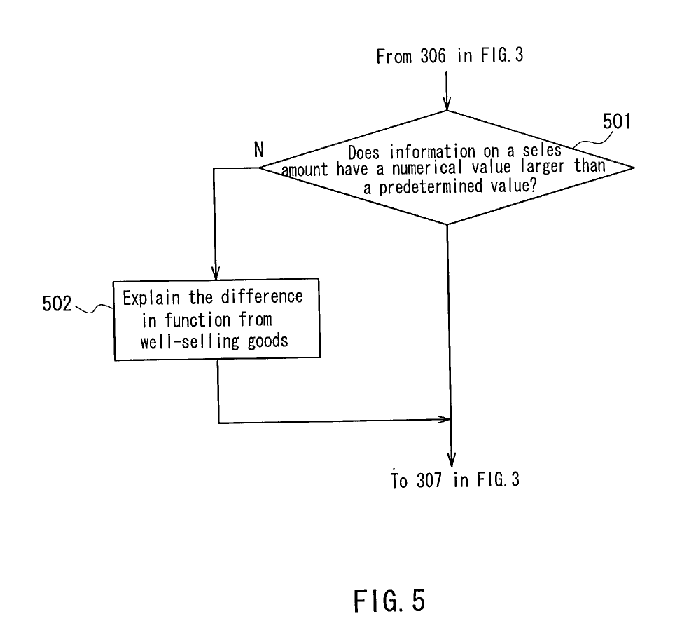

FIG. 5 is a view showing an example of the control of a flow in dialog control processing using sales amount information of goods. In the flow chart in FIG. 5, the same processing parts as those in FIG. 3 are not shown.

After the goods are presented in Operation 306 in FIG. 3, it is confirmed whether or not the presented goods show a numeric value larger than a predetermined value in sales amount information among goods information data shown in FIG. 2B (Operation 501). If the sales amount is larger than a predetermined value (Operation 501: Y), i.e., if the goods are hot-selling products, confirmation of the purchase thereof in FIG. 3 is conducted (Operation 307). If the goods are not hot-selling products (Operation 501: N), the difference in function between the goods and the hot-selling goods is extracted from the function information of the goods information data shown in FIG. 2B for explanation (Operation 502). Herein, a goods sales strategy using the comparison with hot-selling goods was conducted. For example, in the case where the hot-selling goods are inferior in function which the user seeks for, when the inferior function is explained, there is an effect of enhancing the reliability of the recommended goods. Such a sales strategy is stored in the goods sales strategy knowledge part 60.

There is also a goods sales strategy in which goods selected in a demand investigation mode are compared with the goods recommended by a sales entity, whereby the goods recommended by the sales entity are allowed to appeal to the user. More specifically, it is confirmed whether or not the goods selected in the demand investigation mode are those which are recommended by the sales entity. If the goods are those which are recommended by the sales entity, confirmation of the purchase in FIG. 3 is conducted (Operation 307). If the goods are not those which are recommended by the sales entity, the goods selected in the demand investigation mode are used as goods for comparison, and the difference in function from the recommended goods is extracted from the function information of the goods information data shown in FIG. 2B for explanation. Thus, the advantage of the recommended goods is allowed to appeal to the user.

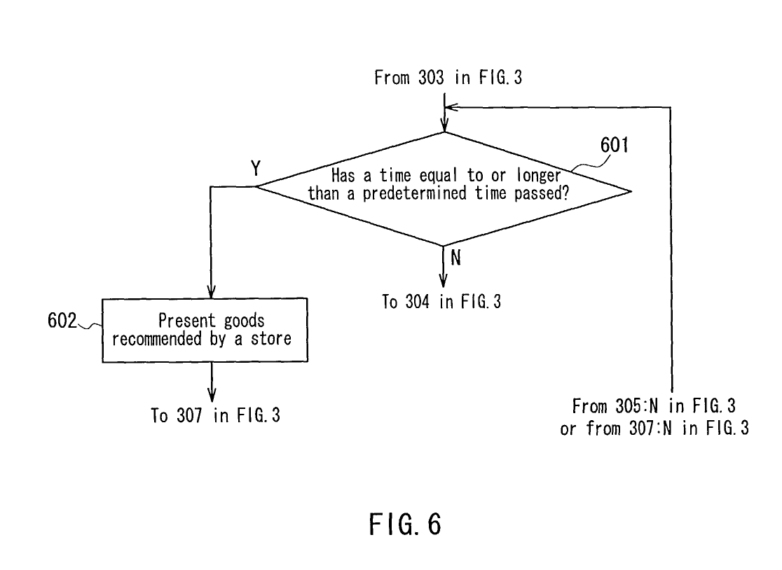

Next, FIG. 6 shows a dialog flow of introducing goods recommended by a store when a dialog time becomes long. In the flow chart in FIG. 6, the same processing parts as those in FIG. 3 are not shown.

When it takes a predetermined time or longer for a greeting phase (Operation 301), collection of information on the user (Operation 302), collection of information on a category of purchased goods (Operation 303), and the like, or when the processing of demand investigation (Operation 304) and confirmation of purchase (Operation 307) is repeated to take a predetermined time or longer (Operation 601: Y), the goods recommended by a store are presented (Operation 602) without returning to the demand investigation (Operation 304), and the process proceeds to the confirmation of purchase (Operation 307) in FIG. 3, whereby a dialog time is shortened.

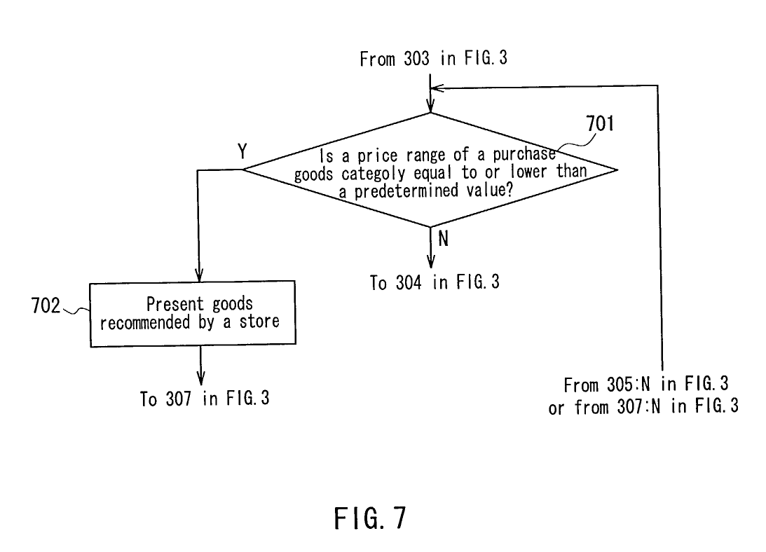

Next, another pattern of the control of a dialog flow will be described. FIG. 7 shows an example in which a dialog flow is varied depending upon the price range of a goods category and the price of recommended goods. When the price of goods is high, a time limit is prolonged, and when the price of goods is low, a time limit is shortened. The reason for this is as follows: when the price of goods is high, the user tends to be careful, and the store also allows the user to select goods carefully since a unit price is high. On the contrary, when the price of goods is low, i.e., when a unit price is considered to be low, a time taken for the user to determine to purchase the goods is shortened by a speedy response.

After the greeting phase (Operation 301), the collection of information on the user (Operation 302), and the collection of information on a category of purchased goods (Operation 303), it is checked whether or not the price range of a category of user's purchased goods is equal to or lower than a predetermined value. When the price range is equal to or lower than a predetermined value (Operation 701: Y), the goods recommended by a store are presented (Operation 702) without returning to the demand investigation (Operation 304), and the process proceeds to the confirmation of purchase (Operation 307), whereby a dialog time is shortened. When the price range of a category of purchased goods is not equal to or lower than a predetermined value (Operation 701: N), the process proceeds to the demand investigation (Operation 304) in FIG. 3, whereby the process does not directly proceed to the presentation of recommended goods.

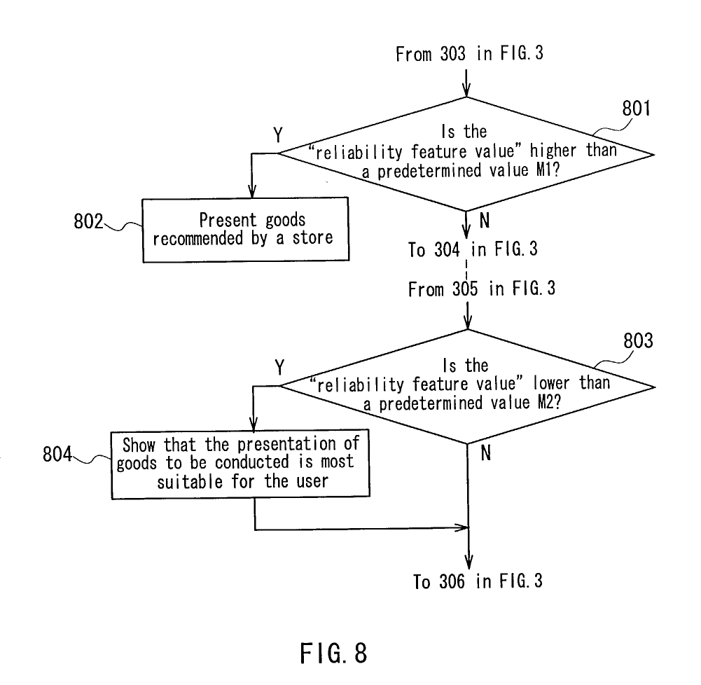

Next, FIG. 8 shows an example of processing of a dialog in which it is confirmed whether or not the goods are purchased at that store after the demand investigation. Herein, a dialog control is combined with an example in which a dialog flow is changed in accordance with the level of reliability of a sales entity. Furthermore, two threshold values M1 and M2 are provided regarding the level of reliability. Herein, M2 is a numerical value smaller than M1, and the standard of this numerical value is tuned to a level at which the reliability of a store is low and the user may be suspicious about the recommendation of the system.

After the greeting phase (Operation 301), the user information collection phase (Operation 302), and the goods category information collection phase (Operation 303), it is checked whether or not the “reliability feature value” obtained from the user information obtained in Operation 302 is higher than the predetermined value M1 (Operation 801). When the “reliability feature value” is higher than the predetermined value M1 (Operation 801: Y), goods recommended by a store are presented (Operation 802). Regarding the user whose “reliability feature value” is not higher than the predetermined value M1 (Operation 801: N), the demand investigation phase in FIG. 3 is conducted (Operation 304). Then, the “reliability feature value” at the end of the demand investigation is confirmed, and it is checked whether or not the “reliability feature value” is lower than the predetermined value M2 (Operation 803). When the “reliability feature value” is lower than the predetermined value M2 (Operation 803: Y), a dialog is designed so as to show that the presentation of goods to be conducted is most suitable for the user (Operation 804). Because of this, it can be emphasized that the recommendation by the system to the user is suitable for user's demand.

The processes after the presentation of goods (Operation 306) in FIG. 3 and the other processes not described in the above are the same as those in FIG. 4. Therefore, the description thereof will be omitted here.

Next, an example of the contents to be displayed in relation to goods when the goods are presented. For presentation of the goods, the name, manufacturer, and price thereof are presented. In addition, if the advantage of the goods with respect to the other products and the disadvantage in function thereof are held as goods information data in the goods knowledge part 50, such information can also be presented. The disadvantage refers to that a certain specification of the goods is lower than an average of a group of other goods belonging to the same goods category. By explaining the disadvantage, user's complaints about insufficient explanation after the purchase can be reduced. However, in the case where there are other products with the same disadvantage, by presenting the information that there are other goods with the same disadvantage, the frequency of the user's rejection to the purchase of presented goods can be decreased. Furthermore, by explaining the advantage of the goods repeatedly at this stage irrespective of whether the explanation is repeated, the frequency of the user's rejection to the purchase of presented goods can be decreased.

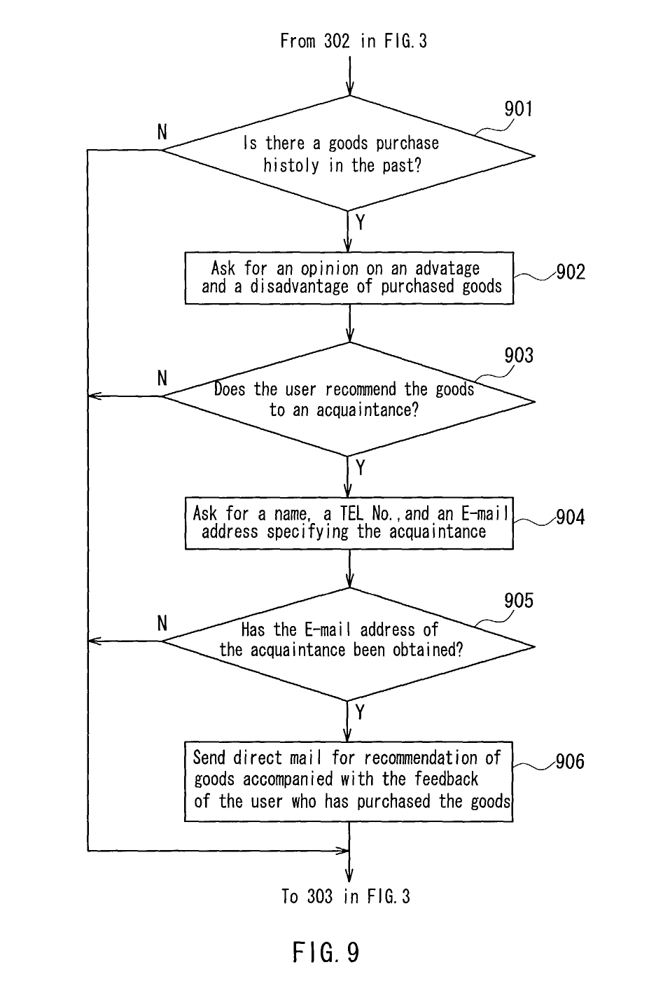

Next, an example of a dialog in the case where the user who has purchased goods by using the system visits a store again will be described with reference to FIG. 9. In the greeting phase (Operation 301) in FIG. 3 to the user information collection phase (Operation 302), a user is specified. When a user ID is known, a history of the purchase of goods in the past can be checked by using the user knowledge part 41. Furthermore, a dialog of a question of asking for a history of visits in the past may be inserted in the user information collection phase. When there is a history of the purchase of goods in the past (Operation 901: Y), a dialog for asking for an opinion on the advantage and disadvantage of the purchased goods is inserted (Operation 902). The “reliability feature value” is varied depending upon the contents of the answer to the question. Furthermore, it should be understood that the answer becomes very important information on the goods, and the impression of the user regarding the obtained goods can be added to the goods knowledge as the information on the goods. The use frequency of the goods is varied depending upon the goods category. Therefore, in the case where the use frequency is high, the above-mentioned question is made even with respect to the access after several days. In the case where the goods with a low use frequency, the above-mentioned question is made with respect to an access after a predetermined period of time has elapsed. Thus, more exact user's impression on the goods can be obtained. Furthermore, the following can also be conducted as an application pattern: after an impression on goods purchased in the past is asked for in Operation 902, a dialog flow is controlled so as to ask the user whether or not the user will recommend the goods to an acquaintance (Operation 903). Furthermore, in the case where the user has an intention of recommending the goods (Operation 903: Y), a dialog is controlled so as to ask for the information identifying the acquaintance (i.e., a name, TEL No., E-mail address) (Operation 904). The data thus obtained is stored as user information data. If the E-mail address of the acquaintance is obtained (Operation 905: Y), direct mail of recommendation of goods accompanied by the impression of the user who has purchased goods can be sent to the acquaintance (Operation 906).

In the above example, user's acquaintance is specified, and direct mail of recommendation of goods is sent thereto. However, the destination of the direct mail is not limited to a particular acquaintance of the user. Recommendation information of the goods may be set so that anyone can see it as in a kind of electronic bulletin board.

Still another example of the control of a dialog flow will be described.

It may also be considered that after the dialog with the user starts, the dialog is suspended before the user decides to purchase goods. In this case, the dialog state at that time (i.e., various kinds of feature values such as user's “demand feature value” and user's “reliability feature value”, and information on the other users) are stored in the system. Because of this, when the same user utilizes the system at another opportunity, the user can continue the dialog from the suspended state. However, there is possibility that the user may have changed his/her mind at this point. Therefore, emotional feature values that can be assumed to be changed with time, such as the “user's reliability of a store”, is decreased in accordance with an elapse of a time from the previous dialog time, whereby a dialog flow can be controlled so that goods recommended by the store are not presented immediately. When the elapsed time is short, the user remembers the contents of the previous dialog to some degree. Therefore, even if the goods recommended by the store are presented immediately, it is expected that the user is hardly at a loss.

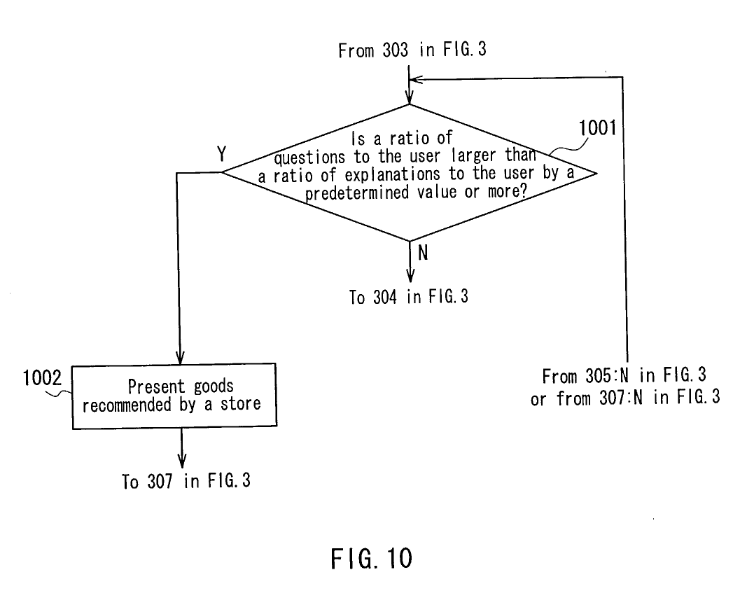

Next, the number of questions and the number of explanations made with respect to the user are recorded. An example of the control of a dialog flow in the case where either one of them is remarkably increased (for example, the number of questions is twice or more the number of explanations) will be described with reference to FIG. 10. This is assumed in the case where the user does not answer to the questions from the system, or a part of the answers is mostly lost. This situation is mostly found when user's demand is unclear; as a result, goods cannot be narrowed down only by the demand investigation with respect to the user. Thus, a dialog flow is controlled to the phase of recommendation of goods.

During the greeting phase (Operation 301), the collection of information on the user (Operation 302), and the collection of information on a category of purchased goods (Operation 303) in FIG. 3, and after the processing of the demand investigation (Operation 304) and the like are repeated, it is checked whether or not the ratio of the number of dialogs of the questions from the user to the system is larger by a predetermined value or more, compared with the ratio of the time of dialogs of the explanations from the system to the user (i.e., whether or not the ratio of questions with respect to the user is larger by a predetermined value or more, compared with the ratio of explanations with respect to the user (Operation 1001). If the ratio is larger by a predetermined value or more (Operation 1001: Y), goods recommended by a store are presented (Operation 1002) without returning to the demand investigation (Operation 304). Even in the case where the user has no intention of purchasing the recommended goods in Operation 1002 (Operation 307: N), if a dialog flow is controlled to a question based on the comparison with the recommended goods, a required demand feature value can be collected quickly.

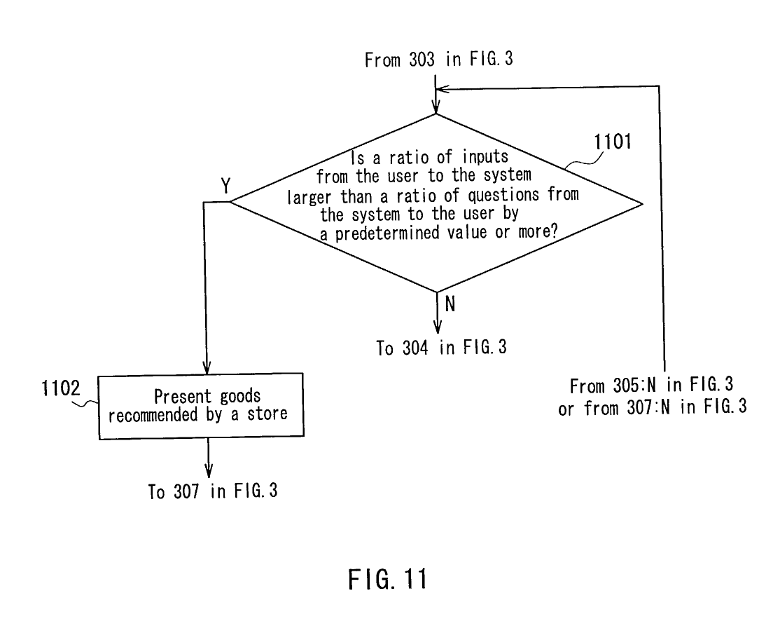

In the above example, the ratio of questions from the system to the user is larger than the ratio of explanations with respect to the user. However, the ratio of inputs from the user to the system may be larger by a predetermined value or more, compared with the ratio of questions from the system to the user. This situation is assumed, for example, in the case where the user becomes very careful and tends to repeat minute questions, in the case where the user inputs information including minute points, and in the case where the user inputs topics that are not closely related to the purchase of goods. In such a case, a dialog flow is changed to suggestion in which the recommended goods are presented, whereby a dialog time is shortened. In FIG. 11, the operation corresponding to Operation 1001 in FIG. 10 is replaced by a processing operation (Operation 1101) in which it is confirmed whether or not the ratio of inputs from the user to the system is larger by a predetermined value or more, compared with the ratio of questions from the system to the user (Operation 1101). In the case where the input ratio of the user is larger by a predetermined value or more (Operation 1101: Y), the goods recommended by a store are presented (Operation 1102) without returning to the demand investigation (Operation 304).

The ratio of questions and the ratio of explanations from the user to the system may be calculated by the number of times or by the period of time. If the ratio in terms of the dialog time instead of the number of dialogs is evaluated, in the case where the time during which the system asks the user questions is long, the ratio can be changed so as to suppress this situation. The question time from the system to the user may be obtained by accumulating the time during which the system asks questions via the dialog interface 10. The question time is defined as the period of time from the output of the contents of a dialog of questions via the dialog interface 10 to the input of the contents of a dialog of answers via the dialog interface 10.

Furthermore, the dialog flow control part 70 checks the dialog contents history holding part 30. In the case where at least one of the history number of times on the basis of contents of questions from the system to the user and the history number of times on the basis of contents of explanations from the system to the user exceeds a predetermined number of times, the dialog flow control part 70 can control the flow of the dialog contents by inferring the contents of a dialog to be output so that the contents of questions or the contents of explanations are not repeated. In this case, it is assumed that a dialog flow of questions, answers, and explanations forms a kind of loop, and the same question, answer, and explanation may be repeated. In this case, the dialog flow control part 70 changes a dialog flow so as to eliminate the loop.

Next, an application function will be described. The dialog control system can control a dialog flow in such a manner as to estimate and notify a time required for the user to decide to purchase goods after the commencement of a dialog. The user knowledge part 41 can hold a time required for each user to purchase goods in the past. If the past required time is averaged on the user basis, a time required for the user of interest to purchase goods can be estimated. Furthermore, instead of that the required time is estimated on the user basis, an average required time of all the users or of a user group narrowed down based on the attributes of the users may be calculated to obtain an estimated required time. As a dialog for notifying an estimated required time, for example, a message that “It will take you about XX minutes to purchase goods. Is that OK?” is given. Furthermore, in the case where a dialog of notifying an estimated time required for purchasing goods is made as described above, when the notified required time has passed in the course of a dialog with the user, it is possible to control a dialog flow so as to provide notification “The time notified first has passed. Would you like to continue to use the system?”. Thus, estimation and notification of a required time is important information for a user in a hurry or a user having no time, and has an effect of enhancing the satisfaction of a customer.

Another application function will be described. In the case where there are a plurality of questions from the system to the user as the development of a dialog flow, the dialog flow control part 70 can control a dialog flow by classifying the contents of questions from the system to the user based on whether the answers to the questions from the user to the system are in a selection answer form or in a free answer form, and giving a higher priority on the latter rather than the former.

If the questions are classified based on whether the answers are in a selection answer form in which the answers to be assumed are “yes” or “no” or in a free answer form, in the case where there are a plurality of contents of questions with respect to the user, it becomes a problem which dialog content should be output first. As one standard, a question in a selection answer form, which can be answered by “yes” or “no” is output later. This is based on the empirical rule in which the user tends to avoid an operation with a large input load as a time passes by, and has an effect of lowering the frequency at which the user stops a dialog before completion. This empirical rule should be held by the goods sales strategy knowledge part 60.

Similarly, a privacy level is previously set with respect to a question, and in the case where there are some questions simultaneously with respect to the user, questions are made in the increasing order of the privacy level. For example, questions regarding an annual income and an allowance have a high privacy level. A dialog flow is controlled so that these questions are presented later.

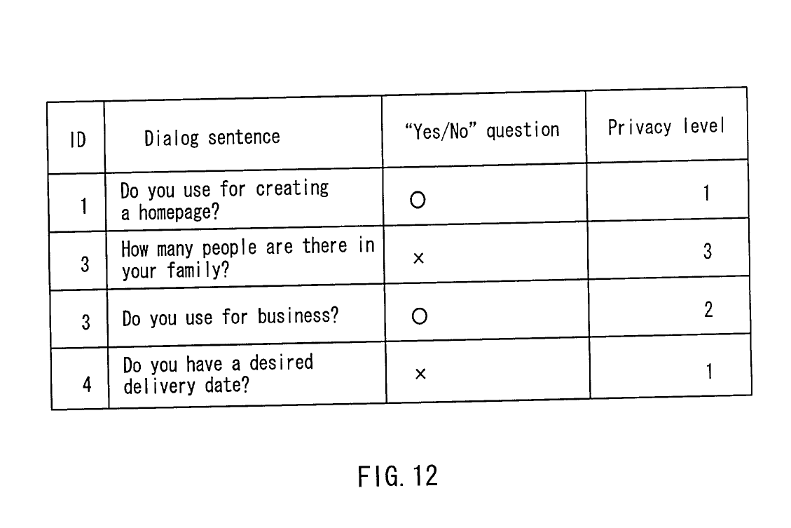

FIG. 12 shows an example of a data configuration of a part of dialog knowledge stored in the dialog knowledge part 71 for controlling the order of output of questions in accordance with the above-mentioned answer form and for controlling the order of output of questions in accordance with the privacy level. The first left column represents a dialog ID, the second left column represents dialog contents, the third left column represents whether or not a question is in a selection answer form, and the fourth left column represents a privacy level. In the case where four dialog contents shown in FIG. 12 are output candidates, the order thereof is as follows: dialog ID 4→1→3→2 or dialog ID 4→1→2→3.

Next, still another application function will be described. The dialog control system can have a function of configuring a customer database. The dialog control system has the dialog contents history holding part 30, which can extract and process information so as to put customer information in a customer database. If required, a history of a dialog contents history and extracted/processed customer information can be obtained from the database.

### Embodiment 2

An example will be described in which the dialog control system of the present invention is configured on the Internet, and a user configures an EC system by using the dialog control system via the Internet. The same description as that in Embodiment 1 will be omitted appropriately.

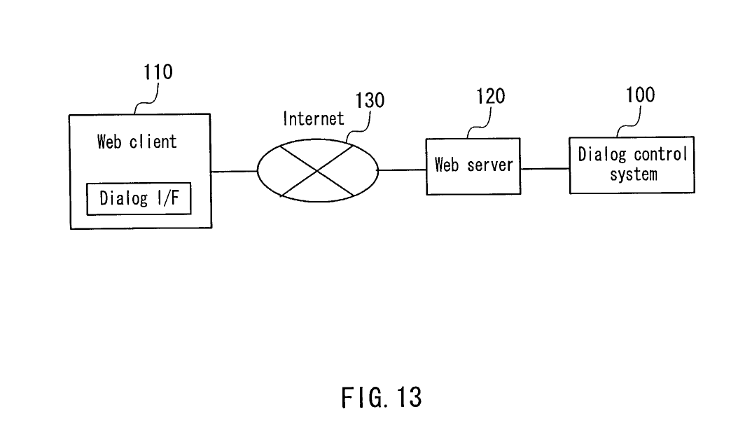

A user uses a web client such as an Internet browser to conduct a dialog with an EC system via a web server. FIG. 13 schematically shows the system. Reference numeral 100 denotes the dialog control system of the present invention. Reference numeral 110 denotes a web client, 120 denotes a web server, 130 denotes the Internet. This system is based on a remote access. Therefore, a dialog interface 10 that exchanges information with the user is provided on the web client 100 side. The dialog control system 100 includes each element described in Embodiment 1: the dialog contents analyzing part 20, the dialog contents history holding part 30, the feature value control part 40, the goods knowledge part 50, the goods sales strategy knowledge part 60, the dialog flow control part 70, and the dialog expression generating part 80.

If the dialog interface 10 is designed for a multimedia, it should be understood that information expressed in a multimedia such as an image, a photograph, an animation, and a voice can be presented in the same way as in Embodiment 1.

Next, an example of a dialog flow by the time when the user purchases goods by using the dialog control system will be briefly described.

First, the dialog flow control part 70 controls so as to allow a user who visits a homepage to conduct a dialog belonging to a greeting phase. For example, “May I help you? Welcome to XX EC”. Herein, if the greeting from the user has the contents such as “Hello, how are you?”, the value of the “reliability feature value” of the feature value control part 40 is increased. In contrast, if the greeting from the user is not good, the value of the “reliability feature value” is decreased.

Next, the dialog flow control part 70 inserts dialog contents of a question for obtaining information identifying the user in the user information collection phase. For example, the dialog flow control part 70 asks a question for identifying a user ID such as “Do you have a courtesy membership No.?”. If a goods purchase history of the user in the past is found from the user ID information, the value of the “reliability feature value” is increased.

A virtual sales store of the EC can also be introduced. The introduction of the store can be omitted if the user has visited the store recently. However, it is effective to give the user recent discount information of the store and information that new products will be dealt in.

In the dialog flow of the EC via the Internet, there is one processing advantageous to the sales store, in which user's acquaintance introduction mail, goods recommendation electronic mail, and goods recommendation direct electronic mail can be sent on-line. The dialog flow control part 70 can control a dialog flow so as to ask the user if he/she will recommend an acquaintance the same goods. If the dialog content that the user will recommend the same goods is obtained, the dialog flow control part 70 can control a dialog flow so as to ask the information on the acquaintance containing mail address information on the Internet. If the mail address on the Internet is obtained, goods recommendation electronic mail and goods recommendation direct electronic mail can be sent on-line. Needless to say, it is desirable in terms of protection of privacy to conduct a dialog for confirming the user if introduction mail may be sent to the acquaintance before sending such electronic mail.

As described above, in the dialog control system of Embodiment 2, an EC system using the dialog control system of the present invention can be configured via the Internet.

### Embodiment 3

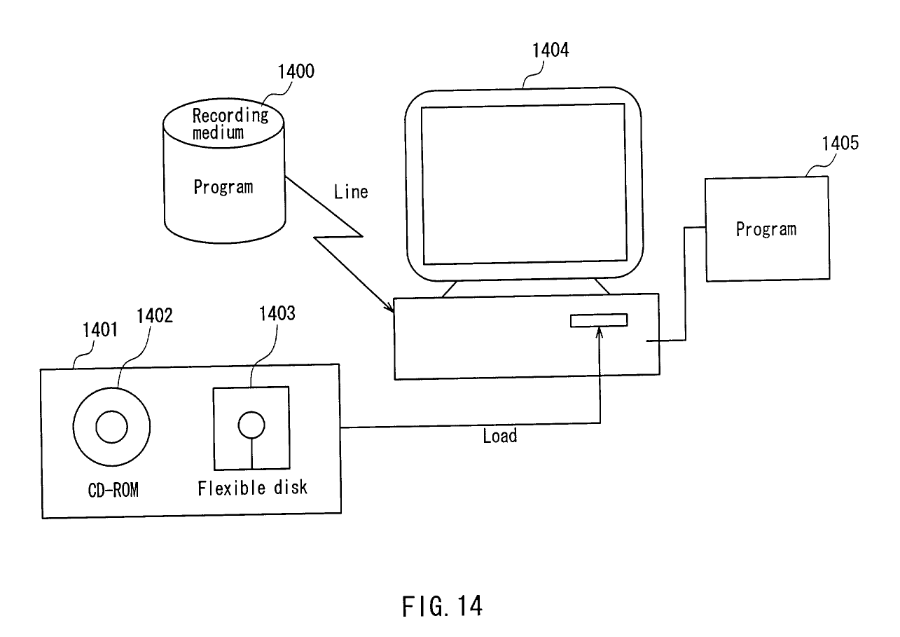

The dialog control system of the present invention can be configured using various kinds of computers by recording a program describing processing operations for realizing the above-mentioned configuration onto a computer-readable recording medium. Examples of recording media storing the program including the processing operations for realizing the dialog control system of the present invention include not only a portable recording medium 1401 such as a CD-ROM 1402 and a flexible disk 1403 but also a recording medium 1400 in a recording apparatus on the network and a recording medium 1405 such as a hard disk and a RAM of a computer, as shown in examples of recording media shown in FIG. 14. During execution, the program is loaded onto the computer 1404, and executed on a main memory.

According to the dialog control system of the present invention, in goods sales by the EC using the Internet, a user can purchase goods in a user-friendly dialog form with a feeling close to face-to-face sales.

Furthermore, according to the dialog control system of the present invention, unlike a conventional static EC sales system, a dynamic and effective sales support adopting an effective goods sales strategy can be conducted.

Furthermore, according to the dialog control system of the present invention, a system is prevented from asking the user questions in a one-sided manner, and an effective sales dialog can be conducted in accordance with a natural dialog flow with the user.

Furthermore, according to the dialog control system of the present invention, goods recommendation information with respect to user's acquaintance and recommended goods information of the general people who are not acquaintances can also be utilized, whereby user's aspiration of purchase can be enhanced.

Furthermore, according to the dialog control system of the present invention, the user is allowed to conduct actions that are likely to be refrained against an actual salesperson, such as suspending of the conversation in the middle thereof and asking of many questions. Therefore, some users can purchase goods more freely, compared with face-to-face sales.

Furthermore, according to the dialog control system of the present invention, reception service can be automated. Therefore, compared with the conventional over-the-counter sales, labor costs can be suppressed.

1. A dialog control system, comprising:
a dialog interface for inputting/outputting a dialog with a user;
a dialog contents analyzing part for analyzing contents of the dialog input by the user;
a feature value control part for extracting/managing one or a plurality of feature values to be parameters for evaluating a state of the user based on analysis results of the contents of the dialog by the dialog contents analyzing part;
a goods knowledge part for holding goods knowledge;
a goods sales strategy knowledge part concerning a goods sales strategy; and
a dialog flow control part including dialog knowledge, for controlling a dialog flow by inferring contents of a dialog to be output, based on the feature values from the feature value control part, the goods knowledge of the goods knowledge part, the goods sales strategy of the goods sales strategy knowledge part, and the dialog knowledge,
wherein the dialog flow is controlled in accordance with the state of the user.

2. A dialog control system according to claim 1, comprising a dialog contents history holding part for holding a history of the contents of the dialog,
wherein the dialog flow control part controls the dialog flow by inferring the contents of the dialog to be output, based on a dialog history from the dialog contents history holding part, the feature values from the feature value control part, the goods knowledge of the goods knowledge part, the goods sales strategy of the goods sales strategy knowledge part, and the dialog knowledge.

3. A dialog control system according to claim 1, comprising a dialog expression generating part having dialog expression knowledge holding knowledge regarding a dialog expression, for generating/outputting the contents of the dialog inferred by the dialog flow control part as a dialog expression in accordance with attributes of the user.

4. A dialog control system according to claim 1, wherein one of the feature values represents reliability of a sales entity of the user, and
the dialog contents analyzing part analyzes/extracts contents representing the reliability of the sales entity of the user from the contents of the dialog input by the user, and increases/decreases the feature values representing the reliability.

5. A dialog control system according to claim 4, comprising a user recognizing part for recognizing a user individually and a timer for managing an access time on a user basis,
wherein the feature values include a feature value representing an elapsed time from a previous access time to a current access time on a user basis and a feature value representing an access frequency on a user basis, and
the feature value representing the reliability of the sales entity of the user extracted by the dialog contents analyzing part is combined with the feature value representing the elapsed time and the feature value representing the access frequency to evaluate the reliability of the sales entity of the user.

6. As dialog control system according to claim 1, wherein one of the feature values is a feature value representing a demand of the user for goods regarding a function and quality,
the dialog flow control part controls a flow of the contents of the dialog by inferring the contents of the dialog to be output so as to obtain contents of a dialog for extracting the demand of the user for the goods as a demand investigation mode, and
the dialog flow control part infers goods matching or satisfying the feature value representing the demand of the user for the goods, based on a dialog history of the demand of the user for the goods and the goods knowledge of the goods knowledge part, and deals with the goods as recommended goods.

7. A dialog control system according to claim 6, wherein the sales entity comprises a recommended goods specifying part for specifying goods of which sales is recommended,
the goods knowledge part contains information on the recommended goods, information on comparison goods to be a comparison object belonging to a goods category to which the recommended goods belong, and information on an advantage of the recommended goods with respect to the comparison goods, and
the dialog flow control part controls a flow of contents of a dialog by inferring the contents of the dialog to be output so as to obtain contents presenting the information on the advantage of the recommended goods to the user based on specification of the recommended goods input from the recommended goods specifying part.

8. A dialog control system according to claim 7, wherein the goods knowledge part comprises disadvantage information on a disadvantage of the comparison goods with respect to the recommended goods, and
the dialog flow control part controls a flow of contents of a dialog by inferring the contents of the dialog to be output so as to obtain contents presenting the information on the disadvantage of the comparison goods before obtaining contents presenting the information on the advantage of the recommended goods to the user.

9. A dialog control system according to claim 7, wherein one of the feature values represents a demand of the user for goods regarding a function and quality, in a case where the feature value representing the demand does not satisfy a predetermined value, the dialog flow control part controls a flow of contents of a dialog by inferring the contents of the dialog to be output so as to obtain contents of a dialog for obtaining the demand of the user for the goods as a demand investigation mode, and
in a case where a predetermined time has passed after shifting to the demand investigation mode, the demand investigation mode is completed, and the recommended goods specifying part presents the recommended goods.

10. A dialog control system according to claim 7, wherein one of the feature values represents a demand of the user for goods regarding a function and quality, in a case where the feature value representing the demand does not satisfy a predetermined value, the dialog flow control part controls a flow of contents of a dialog by inferring the contents of the dialog to be output so as to obtain contents of a dialog for obtaining the demand of the user for the goods as a demand investigation mode before obtaining contents presenting the information on the advantage of the recommended goods to the user.

11. A dialog control system according to claim 7, wherein one of the feature values represents a demand of the user for goods regarding a function and quality, in a case where the feature value representing the demand does not satisfy a predetermined value, the dialog flow control part controls a flow of contents of a dialog by inferring the contents of the dialog to be output so as to obtain contents of a dialog for obtaining the demand of the user for the goods as a demand investigation mode, and
in a case where the feature value representing the demand satisfies the predetermined value, the dialog flow control part infers goods matching or satisfying the feature value representing the demand of the user for the goods, based on a dialog history of the demand of the user for the goods and the goods knowledge of the goods knowledge part, and deals with the goods as recommended goods.

12. A dialog control system according to claim 11, wherein, in a case where the recommended goods are inferred, the dialog flow control part controls a flow of contents of a dialog by inferring the contents of the dialog to be output so as to obtain contents of a dialog for asking the user a question of confirming whether or not the user intends to purchase goods if goods satisfying the demand are recommended, before setting the dialog flow to contents for suggesting the recommended goods.

13. A dialog control system according to claim 7, wherein the dialog flow control part controls a flow of contents of a dialog by inferring the contents of the dialog to be output so as to obtain contents for presenting the information on the advantage of the recommended goods and describing the information on the disadvantage of the recommended goods and information on the disadvantage of the other goods while using the information on a function of the goods satisfying the demand of the user.

14. A dialog control system according to claim 1, wherein the dialog flow control part controls a flow of contents of a dialog by inferring the contents of the dialog to be output so as to obtain contents for getting satisfaction points and dissatisfaction points regarding the goods purchased by the user

15. A dialog control system according to claim 1, wherein the dialog flow control part controls a flow of contents of a dialog by inferring the contents of the dialog to be output so as to obtain contents for asking the user whether or not the user recommends the same goods to an acquaintance, and in a case of obtaining contents of a dialog of an answer that the user recommends the same goods, controls a flow of contents of a dialog by inferring the contents of the dialog to be output so as to obtain contents for seeking for information on the acquaintance containing address information of the acquaintance on the Internet, thereby obtaining the information on the acquaintance.

16. A dialog control system according to claim 1, wherein the dialog flow control part controls a flow of contents of a dialog by checking a dialog history and utilizing a number of histories on a basis of contents of questions from the system to the user, a number of histories on a basis of contents of explanations from the system to the user, a ratio of a number of dialog outputs from the system to the user with respect to a number of dialog inputs from the user to the system, and a ratio of a time of a dialog output from the system to the user with respect to a time of a dialog input from the user to the system, thereby inferring the contents of the dialog to be output.

17. A dialog control system according to claim 1, wherein the dialog flow control part controls, as development of the dialog flow, a dialog flow by classifying contents of questions from the system to the user based on whether answers to the questions from the user to the system are in a selection answer form or in a free answer form, in a case where there are a plurality of questions from the system to the user, and giving a higher priority on the latter rather than the former.

18. A dialog control system according to claim 1, wherein the dialog flow control part controls, as development of the dialog flow, a dialog flow by ranking contents of questions from the system to the user in accordance with a privacy level in a case where there are a plurality of questions from the system to the user, and giving a higher priority on a question at a lower privacy level.

19. A dialog control system according to claim 1, wherein in a client server system using the Internet,
the dialog contents analyzing part, the dialog contents history holding part, the feature value control part, the goods knowledge part, the dialog flow control part, and the dialog expression generating part are provided on a server side, and
the dialog interface is provided on a client side,
whereby a dialog of sales with the user is realized on the Internet.

20. A computer-readable recording medium storing a processing program including processing operations for realizing a dialog control system that controls a dialog flow in accordance with a state of a user, the processing program comprising:
dialog interface control processing of inputting/outputting a dialog with the user;
dialog contents analysis processing of analyzing contents of the dialog input by the user;
feature value control processing of extracting/managing one or a plurality of feature values to be parameters for evaluating the state of the user based on analysis results of the contents of the dialog by the dialog contents analysis processing;
goods knowledge control processing of holding goods knowledge;
goods sales strategy knowledge control processing concerning a goods sales strategy; and
dialog flow control processing of controlling a dialog flow by inferring contents of a dialog to be output to the user, based on dialog knowledge, the feature values in the feature value control processing, the goods knowledge in the goods knowledge control processing, and the goods sales strategy in the goods sales strategy knowledge control processing.
